(19) United States
(12) Patent Application Publication
(10) Pub. No.: US 2020/0298832 A1
(43) Pub. Date: Sep. 24, 2020

(54) PARKING SUPPORT APPARATUS

(71) Applicant: AISIN SEIKI KABUSHIKI KAISHA, Kariya-shi, Aichi (JP)

(72) Inventors: Nozomu MAEDA, Kariya-shi, Aichi-ken (JP); Hironori HIRATA, Anjo-shi, Aichi-ken (JP); Masahiro ISHIHARA, Nishio-shi, Aichi-ken (JP)

(73) Assignee: AISIN SEIKI KABUSHIKI KAISHA, Kariya-shi, Aichi (JP)

(21) Appl. No.: 16/607,264

(22) PCT Filed: Mar. 1, 2018
(86) PCT No.: PCT/JP2018/007790

§ 371 Date: Oct. 22, 2019

(30) Foreign Application Priority Data
Apr. 24, 2017 (JP) 2017-085351

(51) Int. Cl. B60W 30/06; B60W 10/20

(52) U.S. Cl. CPC B60W 30/06; B60W 2720/24; B60W 2710/207; B60W 10/20

(57) ABSTRACT

A parking support apparatus according to an embodiment includes: a memory configured to store in advance a plurality of movement routes having different turning radii of a vehicle; and a hardware processor coupled to the memory, the hardware processor being configured to: select one movement route from the plurality of movement routes based on magnitude of difference between a direction of the vehicle to a target position at a turning-back position where the vehicle turns back and a direction of the vehicle to the target position when the vehicle is positioned on the movement route; and move the vehicle based on the selected movement route.

### TECHNICAL FIELD

Embodiments of the present invention relate to a parking support apparatus.

### BACKGROUND ART

Conventionally, parking support apparatuses that perform parking support by automatic steering have been known. The parking support apparatuses guide a vehicle along a movement route specified based on the positional relation between a parking area and the vehicle.

### CITATION LIST

### Patent Literature

Patent Document 1: Japanese Patent Application Laid-open No. 2010-269707

### SUMMARY OF INVENTION

### Problem to be Solved by Invention

However, the vehicle may be deviate the specified movement route due to various factors, such as operations performed by a driver, parking environment, or difference in operations between vehicles. In such case of the conventional parking support apparatus, parking accuracy is lowered and turning-back operations to correct the parking position are increased. There is a demand for parking support apparatuses that can guide a vehicle to a target position with higher accuracy.

### Means for Solving Problem

A parking support apparatus according to an embodiment of the present invention includes, for example: a storage unit configured to store in advance a plurality of movement routes having different turning radii of a vehicle; a selecting unit configured to select one movement route from the plurality of movement routes based on magnitude of difference between a direction of the vehicle to a target position at a turning-back position where the vehicle turns back and a direction of the vehicle to the target position when the vehicle is positioned on the movement route; and a movement control unit configured to move the vehicle based on the selected movement route. The parking support apparatus according to the embodiment can guide the vehicle to the target position with higher accuracy.

The parking support apparatus further includes, for example, an inclination calculating unit configured to calculate a vehicle inclination angle that is an intersection angle between a longitudinal direction of the vehicle at the turning-back position and a first direction extending along an entrance of a target parking area, and a movement route inclination angle that is an intersection angle between the first direction and the longitudinal direction of the vehicle at an intersection of the movement route and a reverse start reference line being parallel to a second direction perpendicular to the first direction and passing through the turning-back position. The target parking area includes the target position. The selecting unit selects the movement route having an absolute value of difference between the vehicle inclination angle and the movement route inclination angle equal to or smaller than a threshold. Consequently, the parking support apparatus according to the embodiment can reduce the number of movement routes stored in the storage unit while securing parking accuracy of a predetermined level or higher.

In the parking support apparatus, for example, the movement route that turns at a position closer to the target parking area out of the plurality of movement routes has a smaller turning radius. The selecting unit selects the movement route closer to the target parking area than the turning-back position is. Consequently, the parking support apparatus according to the embodiment can prevent the vehicle from passing on frame lines and the like surrounding the target parking area, thereby guiding the vehicle to the target parking area with higher accuracy.

In the parking support apparatus, when there are movement routes being selectable, the selecting unit selects the movement route having a smaller absolute value of difference between the vehicle inclination angle and the movement route inclination angle. Consequently, the parking support apparatus according to the embodiment can select the movement route closer to the present position and direction of the vehicle and shift the vehicle to the selected movement route more smoothly.

The parking support apparatus further includes a route correcting unit configured to translate the movement route selected by the selecting unit to the turning-back position in the second direction. Consequently, the parking support apparatus according to the embodiment can perform parking support along the selected movement route from the present position of the vehicle without moving the vehicle to shift it to the selected movement route.

### BRIEF DESCRIPTION OF DRAWINGS

FIG. 1 is an exemplary perspective view illustrating part of a cabin of a vehicle according to an embodiment in a cutaway manner;

FIG. 2 is a diagram of an example of the hardware configuration of a vehicle control system including an ECU according to the embodiment;

FIG. 3 is a block diagram of an example of the functional configuration of the ECU according to the embodiment;

FIG. 4 is a view of an example of resetting routes according the embodiment;

FIG. 5 is a view of an example of offsetting the resetting route according to the embodiment;

FIG. 6 is a flowchart of an example of a process of selecting the resetting route according to the embodiment; and

FIG. 7 is a diagram for explaining an example of conventional techniques.

### DESCRIPTION OF EMBODIMENTS

Exemplary embodiments of a parking support apparatus according to the present embodiment mounted on a vehicle 1 are described below.

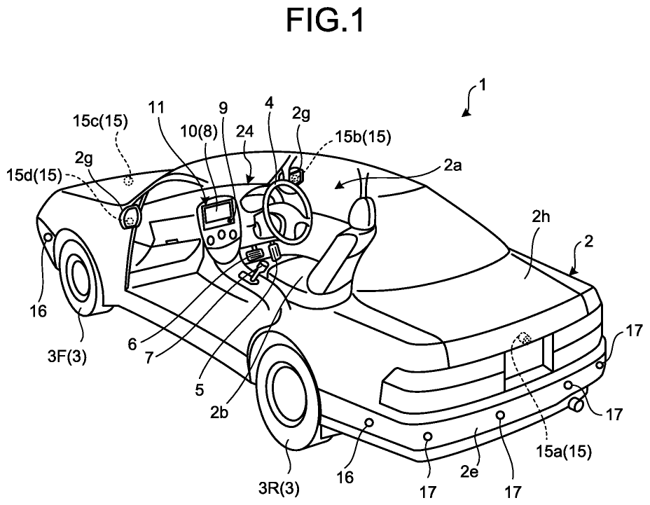

FIG. 1 is an exemplary perspective view illustrating part of a cabin 2a of the vehicle 1 according to the present embodiment in a cutaway manner. The vehicle 1 provided with a vehicle control device according to the present embodiment may be a car including an internal combustion engine, which is not illustrated, as a driving source, that is, an internal combustion engine car, for example. Alternatively, the vehicle 1 may be a car including a motor, which is not illustrated, as a driving source, that is, an electric car or a fuel cell car, for example. Still alternatively, the vehicle 1 may be a hybrid car including an internal combustion engine and a motor as a driving source or a car including another driving source. The vehicle 1 may be provided with various transmissions and various devices, such as systems and parts needed for driving the internal combustion engine and the motor.

As illustrated in FIG. 1, a vehicle body 2 defines the cabin 2a in which a passenger, which is not illustrated, rides. The cabin 2a is provided with a steering unit 4, an acceleration operating unit 5, a braking operating unit 6, and a transmission operating unit 7, for example, facing a seat 2b for a driver serving as the passenger.

The steering unit 4 is a steering wheel (handle) protruding from a dashboard 24, for example. The acceleration operating unit 5 is an accelerator pedal provided at the driver's feet, for example. The braking operating unit 6 is a brake pedal provided at the driver's feet, for example. The transmission operating unit 7 is a shift lever protruding from a center console, for example. The steering unit 4, the acceleration operating unit 5, the braking operating unit 6, and the transmission operating unit 7 are not limited thereto.

The cabin 2a is also provided with a display device 8 serving as a display output unit and a sound output device 9 serving as a sound output unit. The display device 8 is a liquid crystal display (LCD) or an organic electroluminescent display (OELD), for example. The sound output device 9 is a speaker, for example. The display device 8 is covered with a transparent operation input unit 10, such as a touch panel. The passenger can visually recognize an image displayed on a display screen of the display device 8 through the operation input unit 10. The passenger can perform an operating input by contacting, pressing, and moving the operation input unit 10 with a finger or the like at a position corresponding to the image displayed on the display screen of the display device 8. The display device 8, the sound output device 9, and the operation input unit 10, for example, are provided to a monitor device 11 positioned at the center of the dashboard 24 in the vehicle width direction, that is, in the lateral direction. The monitor device 11 may include an operation input unit, such as a switch, a dial, a joystick, and a push button, which is not illustrated. The cabin 2a may be provided with a second sound output device, which is not illustrated, at another position different from the position of the monitor device 11. Sound may be output from the sound output device 9 of the monitor device 11 and the second sound output device. The monitor device 11 can also be used as a navigation system and/or an audio system, for example. The cabin 2a may be provided with another display device different from the display device 8.

As illustrated in FIG. 1, the vehicle body 2 is provided with four imaging units 15a to 15d as a plurality of imaging units 15, for example. The imaging unit 15 is a digital camera including an imaging element, such as a charge-coupled device (CCD) and a CMOS image sensor (CIS). The imaging unit 15 can output video data at a predetermined frame rate. The imaging unit 15 successively photographs external environments around the vehicle body 2 including a road surface on which the vehicle 1 can move and an area in which the vehicle 1 can park, and outputs the obtained image as captured image data.

The imaging unit 15a is positioned at a rear end 2e of the vehicle body 2 and provided on a wall at a lower part of a door 2h of a rear trunk, for example. The imaging unit 15b is positioned at a right end of the vehicle body 2, for example. The imaging unit 15b is provided on a right door mirror 2g, for example. The imaging unit 15c is positioned at a front part of the vehicle body 2, that is, at a front end in the vehicle longitudinal direction, for example. The imaging unit 15c is provided on a front bumper, for example. The imaging unit 15d is positioned at a left part of the vehicle body 2, that is, at a left end in the vehicle width direction, for example. The imaging unit 15d is provided on a left door mirror 2g serving as a protrusion, for example. The number of imaging units 15 is not limited to four and may be five or more or one.

As illustrated in FIG. 1, the vehicle 1 is a four-wheel car, for example, and includes two left and right front wheels 3F and two left and right rear wheels 3R. All these four wheels 3 can be steered. The system, the number, the layout, and other aspects of the devices relating to driving the wheels 3 in the vehicle 1 may be appropriately determined.

As illustrated in FIG. 1, the vehicle body 2 is provided with a plurality of distance measuring units 16 and 17. The distance measuring units 16 and 17 are sonars (sonar sensors or ultrasonic locators) that output ultrasonic waves and receives reflected waves, for example. The distance measuring units 17 are used to detect an object present in a relatively short distance, for example. The distance measuring units 16 are used to detect an object present in a relatively long distance compared with the distance measuring units 17, for example. The distance measuring units 17 are used to detect an object in front of and behind the vehicle 1, for example. The distance measuring units 16 are used to detect an object at sides of the vehicle 1. The numbers and the positions of the distance measuring units 16 and 17 provided to the vehicle body 2 are not limited to those in the example illustrated in FIG. 1.

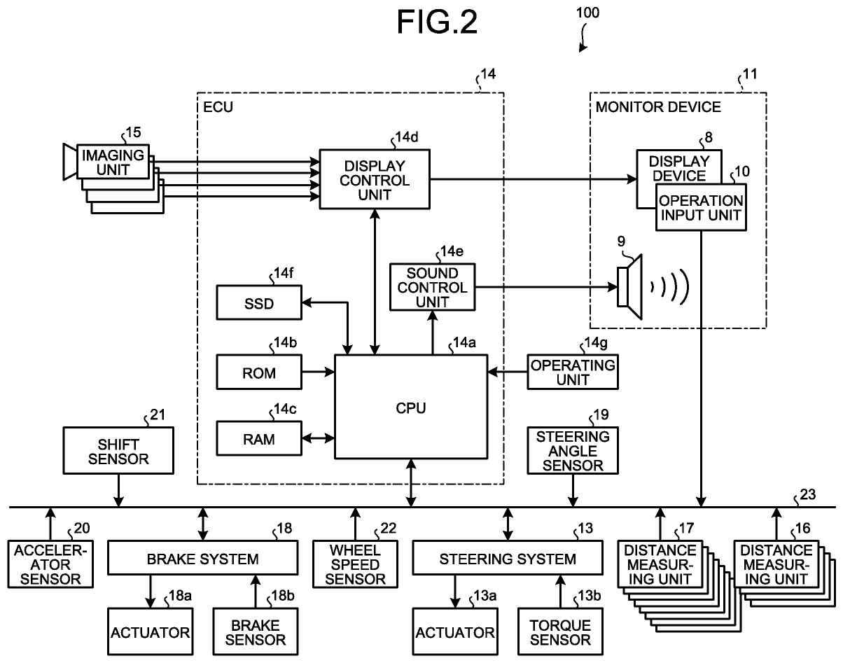

FIG. 2 is a diagram of an example of the hardware configuration of a vehicle control system 100 including an electronic control unit (ECU) 14 according to the present embodiment. As illustrated in FIG. 2, the vehicle control system 100 includes the ECU 14, the monitor device 11, a steering system 13, the distance measuring units 16 and 17, a brake system 18, a steering angle sensor 19 (angle sensor), an accelerator sensor 20, a shift sensor 21, and a wheel speed sensor 22, for example. These components are electrically connected via an in-vehicle network 23 serving as an electrical communication line.

The in-vehicle network 23 is a controller area network (CAN), for example.

The ECU 14 transmits control signals via the in-vehicle network 23, thereby controlling the steering system 13, the brake system 18, and other components. The ECU 14 can receive detection results from a torque sensor 13b, a brake sensor 18b, the steering angle sensor 19, the distance measuring units 16 and 17, the accelerator sensor 20, the shift sensor 21, and the wheel speed sensor 22 and instruction signals (control signals, operating signals, input signals, and data) from the operation input unit 10, for example, via the in-vehicle network 23. The ECU 14 is an example of the parking support apparatus according to the present embodiment.

The ECU 14 includes a central processing unit (CPU) 14a, a read only memory (ROM) 14b, a random access memory (RAM) 14c, a display control unit 14d, a sound control unit 14e, a solid state drive (SSD or flash memory) 14f, for example.

The CPU 14a reads out a computer program installed and stored in a nonvolatile storage device, such as the ROM 14b, and can perform arithmetic processing based on the computer program. The RAM 14c temporarily stores various kinds of data used in the arithmetic processing performed by the CPU 14a.

The display control unit 14d mainly performs image processing using image data acquired by the imaging units 15 and composes image data to be displayed on the display device 8, for example, in the arithmetic processing performed by the ECU 14. The display control unit 14d, for example, performs arithmetic processing and image processing based on the image data acquired by the imaging units 15. The display control unit 14d thus can generate an image having a wider angle of view and a virtual overhead image of the vehicle 1 viewed from above. The overhead image is also referred to as a plan image.

The sound control unit 14e mainly performs processing on sound data to be output from the sound output device 9 in the arithmetic processing performed by the ECU 14.

The CPU 14a acquires operating signals due to an operating input performed on an operating unit 14g. The operating unit 14g is a push button and/or a switch, for example, and outputs the operating signals.

The SSD 14f is a rewritable nonvolatile storage unit and can store data even when the ECU 14 is turned off. The CPU 14a, the ROM 14b, and the RAM 14c, for example, can be integrated in a single package. Instead of the CPU 14a, the ECU 14 may include another logic arithmetic processor, such as a digital signal processor (DSP), or another logic circuit, for example. Instead of the SSD 14f, a hard disk drive (HDD) may be provided. The SSD 14f and the HDD may be separated from the ECU 14.

The steering system 13 steers at least two wheels 3. The steering system 13 according to the present embodiment steers the front wheels 3F of the vehicle 1. The steering system 13 includes an actuator 13a and a torque sensor 13b. The steering system 13 is electrically controlled by the ECU 14 and other components, thereby causing the actuator 13a to operate. The steering system 13 is an electric power steering system or a steer-by-wire (SBW) system, for example. The steering system 13 adds torque, that is, assist torque to the steering unit 4 by the actuator 13a to supplement the steering force or turns the wheels 3 by the actuator 13a. In this case, the actuator 13a may turn one wheel 3 or a plurality of wheels 3. The torque sensor 13b detects torque supplied to the steering unit 4 by the driver, for example.

The brake system 18 is an anti-lock brake system (ABS) that prevents the brake from locking, an electronic stability control (ESC) that prevents the vehicle 1 from skidding in cornering, an electric brake system that increases brake force (performs brake assist), and/or a brake-by-wire (BBW) system, for example. The brake system 18 supplies braking force to the wheels 3, that is, the vehicle 1 via an actuator 18a. The brake system 18 can detect signs of locking of the brake and spinning and skidding of the wheels 3 based on a difference in rotation between the left and right wheels 3, and can perform various kinds of control. The brake sensor 18b detects the position of a movable part of the braking operating unit 6, for example. The brake sensor 18b can detect the position of the brake pedal serving as the movable part. The brake sensor 18b includes a displacement sensor. The brake sensor 18b transmits detection signals based on an operating input performed on the braking operating unit 6, such as the brake pedal, to the ECU 14 via the brake system 18. Alternatively, the brake sensor 18b may be configured to transmit detection signals based on an operating input performed on the brake pedal to the ECU 14 not via the brake system 18.

The steering angle sensor 19 detects a steering amount (angle of rotation) of the steering unit 4 and is a Hall element, for example. The ECU 14 acquires, from the steering angle sensor 19, the steering amount of the steering unit 4 by the driver and the steering amount of the wheels 3 in parking support by automatic steering, for example, and performs various kinds of control. When the braking operating unit 6 is operated in automatic steering, for example, the ECU 14 can determine that the vehicle 1 is in a state not suitable for automatic steering and suspend or stop automatic steering.

The accelerator sensor 20 detects the position of a movable part of the acceleration operating unit 5, for example. The accelerator sensor 20 can detect the position of the accelerator pedal serving as the movable part. The accelerator sensor 20 includes a displacement sensor.

The shift sensor 21 detects the position of a movable part of the transmission operating unit 7, for example. The shift sensor 21 can detect the position of a lever, an arm, a button, or the like serving as the movable part. The shift sensor 21 may include a displacement sensor. The shift sensor 21 may be a switch.

The wheel speed sensor 22 detects the rotation amount and the rotation rate per unit time of the wheels 3. The wheel speed sensor 22 transmits a wheel speed pulse number indicating the detected rotation rate to the ECU 14 as a sensor value. The wheel speed sensor 22 is a Hall element, for example. The ECU 14 calculates the movement amount and the vehicle speed of the vehicle 1, for example, based on the sensor value acquired from the wheel speed sensor 22 and performs various kinds of control. The wheel speed sensor 22 may be provided to the brake system 18. In this case, the ECU 14 acquires the detection results of the wheel speed sensor 22 via the brake system 18.

The configurations, the positions, the forms of electrical connection, and other aspects of the various sensors and the actuators described above are given by way of example only and may be appropriately determined (changed).

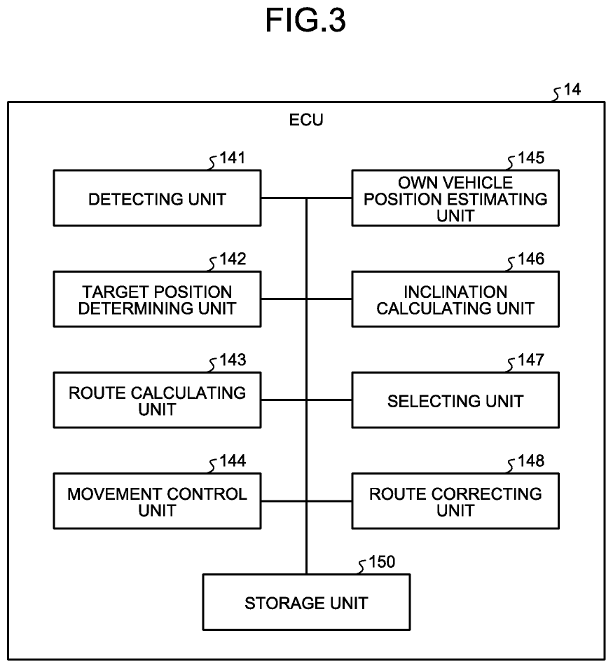

FIG. 3 is a block diagram of an example of the functional configuration of the ECU 14 according to the present embodiment. As illustrated in FIG. 3, the ECU 14 includes a detecting unit 141, a target position determining unit 142, a route calculating unit 143, a movement control unit 144, an own vehicle position estimating unit 145, an inclination calculating unit 146, a selecting unit 147, a route correcting unit 148, and a storage unit 150.

The detecting unit 141, the target position determining unit 142, the route calculating unit 143, the movement control unit 144, the own vehicle position estimating unit 145, the inclination calculating unit 146, the selecting unit 147, and the route correcting unit 148 illustrated in FIG. 3 are provided by the CPU 14a executing a computer program stored in the ROM 14b. These units may be provided by a hardware circuit.

The storage unit 150 is a storage device, such as the SSD 14f, for example. The storage unit 150 stores information indicating a plurality of resetting routes in parking support.

The resetting route is a movement route of the vehicle 1 from a position where the vehicle 1 turns back to a target position in a target parking area when the vehicle 1 moves backward to enter into the target parking area. The resetting route is an example of a movement route according to the present embodiment.

The turning-back position of the vehicle 1 is a position of the vehicle 1 at which the vehicle 1 stops and the movable part of the transmission operating unit 7 is set to the reverse position. In parking support according to the present embodiment, the vehicle 1 is assumed to move forward from a position near the target parking area to a predetermined position, turn back, and then move backward to enter into the target parking area. The turning-back position of the vehicle 1 is also referred to as a reverse start position.

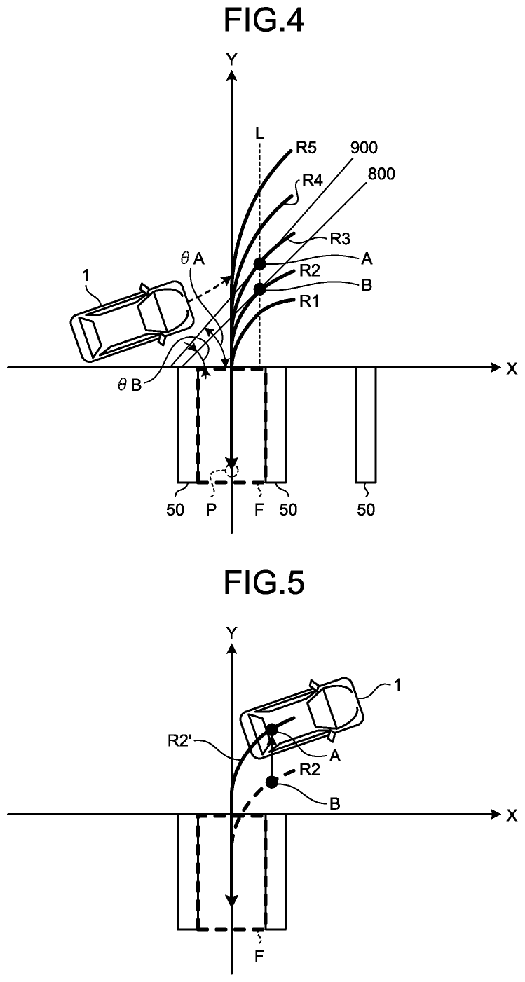

FIG. 4 is a view of an example of resetting routes R according the embodiment. Resetting routes R1 to R5 illustrated in FIG. 4 enable the vehicle 1 to park in a target parking area F. The resetting route R according to the present embodiment enables the vehicle 1 to move to a target position P in the target parking area F, for example. In the following description, the individual routes are referred to as the resetting routes R when they are not particularly specified.

The target parking area F is a rectangular area surrounded by white lines 50, for example. The target position P is a position where the vehicle 1 is assumed to stop when parking support is completed. The target position P is set on the center line extending in the longitudinal direction of the target parking area F, for example.

In the present embodiment, the position of the vehicle 1 is indicated by the position of the center of a rear wheel shaft connecting the two left and right rear wheels 3R of the vehicle 1. Instead of the center of the rear wheel shaft of the vehicle 1, the position of the center of gravity of the vehicle 1 may be employed.

As illustrated in FIG. 4, the resetting routes R1 to R5 each include a turning part and a straight movement part. The resetting routes R1 to R5 have different turning radii in the turning part.

As illustrated in FIG. 4, the resetting routes R1 to R5 stored in the storage unit 150 are set such that a route turning at a position closer to the target parking area F has a smaller turning radius. As the turning radius is smaller, the turning angle of the vehicle 1 is sharper. Typically, as the vehicle 1 turns at a position closer to the target parking area F, the vehicle 1 comes closer to the white lines 50, for example. To prevent the vehicle 1 from passing over the white lines 50 or exceeding the range of the target parking area F, the resetting route R closer to the target parking area F has a smaller turning radius. While the target parking area F according to the present embodiment is surrounded by the white lines 50, it may be surrounded by obstacles, such as other vehicles and poles, depending on the parking places. Setting the resetting routes R as described above can prevent the vehicle 1 from coming into contact with the objects or the like surrounding the target parking area F.

While the turning parts of the respective resetting routes R are partially illustrated in FIG. 4, they further extend in an X-direction illustrated in FIG. 4. While the turning parts are represented as circular arcs in FIG. 4, the storage unit 150 may store the turning parts of the respective resetting routes R as circular routes, for example.

The straight movement parts of the respective resetting routes R are parallel to the longitudinal direction of the target parking area F. The straight movement parts of the respective resetting routes R are also parallel to a Y-direction illustrated in FIG. 4. The standards for setting the X-direction and the Y-direction illustrated in FIG. 4 will be described later.

The straight movement parts of the respective resetting routes R according to the present embodiment are set such that the vehicle 1 moves straight at at least a point where the vehicle 1 enters into the target parking area F. The start position of the straight movement parts of the resetting routes R is not limited thereto and simply needs to be a route that enables the vehicle 1 to park in the target parking area F without passing over the white lines 50. The position shifting from the turning part to the straight movement part in each of the resetting routes R may be determined based on the turning radii of the respective resetting routes R, the model of the vehicle 1, and other factors.

While the storage unit 150 according to the present embodiment stores five types of resetting routes R, the number of resetting routes R stored in the storage unit 150 is not limited thereto.

Referring back to FIG. 3, the detecting unit 141 detects obstacles, such as other vehicles and poles, and frame lines, such as parking section lines, from an image of the periphery of the vehicle body 2 taken by the imaging units 15. The detecting unit 141 detects a parking allowable area in the peripheral area of the vehicle 1 based on the detected obstacles, frame lines, and section lines, for example.

The target position determining unit 142 determines the target parking area F and the target position P of the vehicle 1 based on the detection results of the detecting unit 141. When the detecting unit 141 detects a plurality of parking allowable areas, the target position determining unit 142 may receive a selection operation indicating which parking allowable area is determined to be the target parking area F from the driver. The target position determining unit 142 receives, for example, the selection operation from the driver as the operating signals acquired from the operating unit 14g. In the example illustrated in FIG. 4, the target position determining unit 142 determines the area surrounded by the white lines 50 to be the target parking area F. The target position determining unit 142 determines the target position P in the target parking area F to include the vehicle body 2 within the target parking area F.

Referring back to FIG. 3, the route calculating unit 143 calculates a movement route for moving the vehicle 1 from the present position to the target position P when parking support is started. When receiving an instruction for starting parking support by the operating signals acquired from the operating unit 14g, the route calculating unit 143 calculates a guide route. The movement route of the vehicle 1 calculated by the route calculating unit 143 is referred to as an initial route according to the present embodiment.

While the target position determining unit 142 and the route calculating unit 143 receive operations performed by the driver as the operating signals acquired from the operating unit 14g, the operating input performed by the driver is not limited thereto. The target position determining unit 142 and the route calculating unit 143 may receive operations performed by the driver through the operation input unit 10 and perform the processing described above.

The movement control unit 144 performs steering control to move the vehicle 1 based on the initial route calculated by the route calculating unit 143. Specifically, the route calculating unit 143 controls the actuator 13a of the steering system 13 based on the position of the vehicle 1 such that the vehicle 1 moves along the initial route. At this time, the vehicle 1 is accelerated or decelerated (braked) based on the operation performed by the driver on the acceleration operating unit 5 or the braking operating unit 6. The movement control unit 144 may instruct the driver to perform the operation on the acceleration operating unit 5 or the braking operating unit 6 by displaying guidance on the monitor device 11.

When the vehicle turns back, the selecting unit 147 according to the present embodiment, which will be described later, reviews the movement route. When the selecting unit 147 selects any one of the resetting routes R, the initial route is replaced by the resetting route R. When the selecting unit 147 selects any one of the resetting routes R, the movement control unit 144 moves the vehicle 1 based on the selected resetting route R. Specifically, the movement control unit 144 acquires a result of offsetting (correcting), by the route correcting unit 148, the resetting route R selected by the selecting unit 147. The movement control unit 144 moves the vehicle 1 based on the resetting route R resulting from offsetting. Selecting and offsetting the resetting route R will be described later in detail.

While the movement control unit 144 performs automatic steering, and the driver performs the other operations in parking support according to the present embodiment, the embodiment is not limited thereto. The movement control unit 144 may be configured to automatically control the operation on the acceleration operating unit 5 besides steering, for example. Furthermore, the movement control unit 144 may be configured to automatically control the operation on the transmission operating unit 7.

The own vehicle position estimating unit 145 estimates the position and the direction of the vehicle 1 based on wheel speed information acquired from the wheel speed sensor 22. Specifically, the own vehicle position estimating unit 145 acquires, as a sensor value, the wheel speed pulse number indicating the rotation rate of the wheels 3 detected by the wheel speed sensor 22. The own vehicle position estimating unit 145 calculates the movement amount and the movement direction of the vehicle 1 based on the rotation rates of the two left and right front wheels 3F and the two left and right rear wheels 3R provided on the left and right sides of the vehicle body 2.

The own vehicle position estimating unit 145 detects that the vehicle 1 turns back during parking support. The own vehicle position estimating unit 145 detects, for example, that the vehicle 1 stops and that the movable part of the transmission operating unit 7 is set to the reverse position during parking support. In such case, the own vehicle position estimating unit 145 adds the movement amount and the movement direction of the vehicle 1 after the start of parking support to the position of the vehicle 1 at the start of parking support. The own vehicle position estimating unit 145 thus estimates the turning-back position and the direction of the vehicle 1.

The inclination calculating unit 146 calculates the inclination angle of the vehicle 1 at the turning-back position and calculates the inclination angle of the vehicle 1 on an assumption that the vehicle 1 is positioned on the resetting route R. The calculation of the inclination angles is specifically explained with reference to FIG. 4.

The X-direction illustrated in FIG. 4 extends along the entrance of the target parking area F. The X-direction is also referred to as the width direction or the short direction of the target parking area F. The X-direction is also referred to as a direction perpendicular to an entrance direction and an exit direction of the vehicle 1 to the target parking area F. The X-direction according to the present embodiment is an example of a first direction.

The Y-direction illustrated in FIG. 4 is perpendicular to the X-direction. The Y-direction extends in the longitudinal direction of the target parking area F. The Y-direction is also referred to as the lengthwise direction of the target parking area F. The Y-direction is also referred to as the entrance direction and the exit direction of the vehicle 1 to the target parking area F. The Y-direction according to the present embodiment is an example of a second direction.

In the example illustrated in FIG. 4, the point of intersection of the X-direction and the Y-direction is the midpoint of the length of the target parking area F in the short direction, for example. In the present embodiment, it is assumed that the own vehicle position estimating unit 145 and the inclination calculating unit 146 calculate the X-coordinates and the Y-coordinates of the vehicle 1 and the resetting routes R with respect to the intersection as the origin. It is also assumed that a point positioned in the right direction of the X-direction in FIG. 4 has a larger X-coordinate. It is also assumed that a point positioned in the upper direction of the Y-direction in FIG. 4 has a larger Y-coordinate. The standards for calculating the positions of the vehicle 1, the resetting routes R, and others are not limited thereto.

A point A illustrated in FIG. 4 is the turning-back position of the vehicle 1. The position of the point A is, for example, a position where the driver operates the movable part of the braking operating unit 6 according to the guidance displayed on the monitor device 11 to stop the vehicle 1 and sets the movable part of the transmission operating unit 7 to the reverse position. The position indicated by the point A is hereinafter referred to as a turning-back position A.

The turning-back position A of the vehicle 1 according to the present embodiment is a position where the vehicle 1 actually turns back. Thus, the turning-back position A may be beyond the position for turning-back in the initial route calculated by the route calculating unit 143 or fall short of the position for turning-back. Furthermore, the turning-back position A according to the present embodiment may deviate from the position for turning-back in the initial route due to various factors, such as operations performed by the driver, parking environment, and difference in operations between vehicles. As described above, the turning-back position A is estimated by the own vehicle position estimating unit 145.

A line 900 illustrated in FIG. 4 indicates the longitudinal direction of the vehicle 1 at the turning-back position A. The intersection angle between the line 900 and the X-direction is referred to as a vehicle inclination angle θA of the vehicle 1. The longitudinal direction of the vehicle 1 at the turning-back position A is an example of the direction of the vehicle 1 to the target position P.

The inclination calculating unit 146 estimates the line 900 based on the turning-back position A estimated by the own vehicle position estimating unit 145 and the position of the target parking area F specified by the target position determining unit 142. The inclination calculating unit 146 calculates the vehicle inclination angle θA that is the intersection angle between the line 900 and the X-direction.

A line L illustrated in FIG. 4 is a reverse start reference line L of the vehicle 1. The reverse start reference line L is parallel to the Y-direction and passes through the turning-back position A.

A point B illustrated in FIG. 4 is an intersection point B of the resetting route R2 and the reverse start reference line L. In other words, the intersection point B indicates a position where the X-coordinate of the resetting route R2 is equal to that of the turning-back position A.

A line 800 illustrated in FIG. 4 indicates the longitudinal direction of the vehicle 1 when the vehicle 1 is positioned at the intersection point B on the resetting route R2. The intersection angle between the line 800 and the X-direction is referred to as an inclination angle θB of the resetting route R2. The longitudinal direction of the vehicle 1 at the intersection point B is an example of the direction of the vehicle 1 to the target position P when the vehicle 1 is positioned on the resetting route R.

The inclination calculating unit 146 calculates the position of the intersection point B from the turning-back position A estimated by the own vehicle position estimating unit 145 and the track of the resetting route R2 stored in the storage unit 150. The inclination calculating unit 146 estimates the line 800 based on the position of the intersection point B and the position of the target parking area F. The inclination calculating unit 146 calculates the inclination angle θB of the resetting route R2, which is the intersection angle between the line 800 and the X-direction.

While the intersection point B of the resetting route R2 is representatively illustrated in FIG. 4, the inclination calculating unit 146 also calculates positions of the intersection points B of the reverse start reference line L and the respective resetting routes R1 and R3 to R5. The inclination calculating unit 146 also calculates the intersection angles between the longitudinal direction of the vehicle 1 and the X-direction when the vehicle 1 is positioned on the resetting routes R1 and R3 to R5. In other words, the inclination calculating unit 146 calculates the inclination angle θB of each of the resetting routes R1 to R5. The inclination angle θB of the resetting route R is an example of a movement route inclination angle according to the present embodiment.

The inclination calculating unit 146 calculates the difference between the vehicle inclination angle θA and the inclination angles θB of the respective resetting routes R.

Referring back to FIG. 3, when the vehicle 1 turns back, the selecting unit 147 selects the resetting route R that satisfies conditions from the resetting routes R1 to R5. In other words, the selecting unit 147 reviews the movement route for parking the vehicle 1 in the target parking area F when the vehicle 1 turns back.

Specifically, concerning the first condition, the selecting unit 147 compares a predetermined threshold and an absolute value of the difference between the vehicle inclination angle θA and the inclination angles θB of the respective resetting routes R calculated by the inclination calculating unit 146. The selecting unit 147 extracts resetting routes R having an absolute value of the difference between the vehicle inclination angle θA and the inclination angles θB of the respective resetting routes R equal to or smaller than the predetermined threshold. In the present embodiment, it is assumed that the resetting routes R1 to R4 in the resetting routes R1 to R5 illustrated in FIG. 4 satisfy the first condition.

The threshold is a value indicating an allowable range of the difference in inclination between the vehicle inclination angle θA and the inclination angles θB of the respective resetting routes R. Even when the vehicle inclination angle θA and the inclination angle θB do not completely match, but the absolute value of the difference between the two angles is equal to or smaller than the threshold, the movement control unit 144 will be able to move the vehicle 1 toward the target parking area F along the resetting route R corresponding to the inclination angle θB. With the threshold, the number of resetting routes R stored in the storage unit 150 in advance can be reduced while securing parking accuracy of a predetermined level or higher. The threshold may be determined based on the model of the vehicle 1, for example. The threshold may be stored in the storage unit 150 in advance.

Concerning the second condition, the selecting unit 147 compares the turning-back position A with the position of the intersection point B. The selecting unit 147 extracts a resetting route R having the Y-coordinate of the intersection point B smaller than that of the turning-back position A.

When the Y-coordinate of the intersection point B is smaller than that of the turning-back position A, the distance between the intersection point B and the target parking area F is shorter than that between the turning-back position A and the target parking area F. In other words, the selecting unit 147 extracts the resetting route R closer to the target parking area F than the turning-back position A is. In the example illustrated in FIG. 4, the resetting routes R1 and R2 satisfy the second condition because they are positioned closer to the target parking area F than the turning-back position A is. By contrast, the resetting route R3 does not satisfy the second direction because it passes through a position in the Y-direction with respect to the center of the turning-back position A and is positioned farther away from the target parking area F than the turning-back position A is.

In the example illustrated in FIG. 4, the resetting routes R1 and R2 satisfy both the first condition and the second condition. When there are resetting routes R that satisfy the conditions, the selecting unit 147 selects the resetting route R having a smaller absolute value of the difference between the vehicle inclination angle θA and the inclination angle θB. In the example illustrated in FIG. 4, the resetting route R2 has a smaller absolute value of the difference between the vehicle inclination angle θA and the inclination angle θB than that of the resetting route R1. In this case, the selecting unit 147 therefore selects the resetting route R2 as an object to be reset.

When only one resetting route R satisfies both the first condition and the second condition, the selecting unit 147 selects this resetting route R satisfying the conditions as an object to be reset.

When no resetting route R satisfies both the first condition and the second condition, the selecting unit 147 selects none of the resetting routes R. In this case, the movement control unit 144 resumes parking support for the vehicle 1 based on the initial route. When the movement control unit 144 moves the vehicle 1 based on the initial route and then the vehicle 1 turns back again, selection of the resetting route R is carried out again based on the turning-back position A. When the initial route includes two or more times of turning-back, the selection of the resetting route R is carried out at each of timings of turning-back. When the resetting route R satisfying the conditions is selected at any one of the timings of turning-back included in the initial route, the vehicle 1 may possibly park in the target parking area F by a smaller number of times of turning-back than originally expected.

Furthermore, a case may arise, where it is difficult to continue parking support based on the initial route like a case where the turning-back position A of the vehicle 1 greatly deviates from the initial route. In such cases, the movement control unit 144 may display guidance on the monitor device 11, for example, thereby notifying the driver of termination of parking support or instructing the driver to start manual operations. The driver may newly start parking support by operating the operating unit 14g. When parking support is newly started, the route calculating unit 143 calculates another initial route.

In the present embodiment, both the first condition and the second condition are essential conditions. Alternatively, it is possible to adopt a configuration in which either the first condition or the second condition is essential.

As illustrated in FIG. 4, the target position P according to the present embodiment is included in the target parking area F. In other words, the selecting unit 147 selects one route from a plurality of resetting routes R based on the magnitude of difference between the direction of the vehicle 1 at the turning-back position A to the target position P and the direction of the vehicle 1 to the target position P when the vehicle 1 is positioned on the resetting route R.

Even when the vehicle 1 turns back at a position deviating from the set initial route, the vehicle can park at the target position P by selecting the resetting route R at the turning-back position A by the selecting unit 147. Consequently, deterioration of the parking accuracy is suppressed. Even when errors are accumulated from the start of parking support, those errors can be eliminated by selecting the resetting route R at the turning-back position A by the selecting unit 147. In other words, the ECU 14 according to the present embodiment can guide the vehicle 1 to the target position P with higher accuracy by the selecting unit 147 that selects the resetting route R at the turning-back position A.

Conventionally, when the vehicle is parked within the range of the target parking area, but the parking position of the vehicle deviates from the target position, turning-back operation for correcting the parking position tends to increase. By contrast, according to the present embodiment, the vehicle 1 can park at the target position P by the selecting unit 147 that selecting the resetting route R at the turning-back position A. Consequently, the present embodiment can suppress the increase in the number of turning-back operations.

The selecting unit 147 selects the resetting route R regardless of whether the turning-back position A of the vehicle 1 deviates from the initial route. The turning-back position A is closer to the target parking area F than the position of the vehicle 1 is at the timing when the initial route is calculated. The selecting unit 147 selects the resetting route R at the turning-back position A, thereby selecting the route more suitable for parking the vehicle 1 in the target parking area F. In other words, the selecting unit 147 reviews the movement route at the turning-back position A, thereby increasing the parking accuracy.

Referring back to FIG. 3, the route correcting unit 148 offsets the resetting route R selected by the selecting unit 147. Specifically, the route correcting unit 148 translates the resetting route R selected by the selecting unit 147 to the turning-back position A in the Y-direction.

FIG. 5 is a view of an example of offsetting the resetting route R according to the present embodiment. As illustrated in FIG. 5, the route correcting unit 148 translates the resetting route R2 selected by the selecting unit 147 to the turning-back position A in the Y-direction. Since the X-coordinate of the turning-back position A is equal to that of the intersection point B, the intersection point B shifts to the turning-back position A by the route correcting unit 148 translating the resetting route R2 in the Y-direction. The route resulting from offsetting the resetting route R2 is referred to as a resetting route R2′.

More specifically, as illustrated in FIG. 5, the route correcting unit 148 translates the turning part of the resetting route R2. The straight movement part of the resetting route R2 extends in parallel with the Y-direction by translating the turning part of the resetting route R2 by the route correcting unit 148.

When selection of the resetting route R is carried out, the vehicle 1 stops at the turning-back position A. Thus, the vehicle 1 can move toward the target parking area F from the turning-back position A that is the current stop position by the route correcting unit 148 offsetting the resetting route R2.

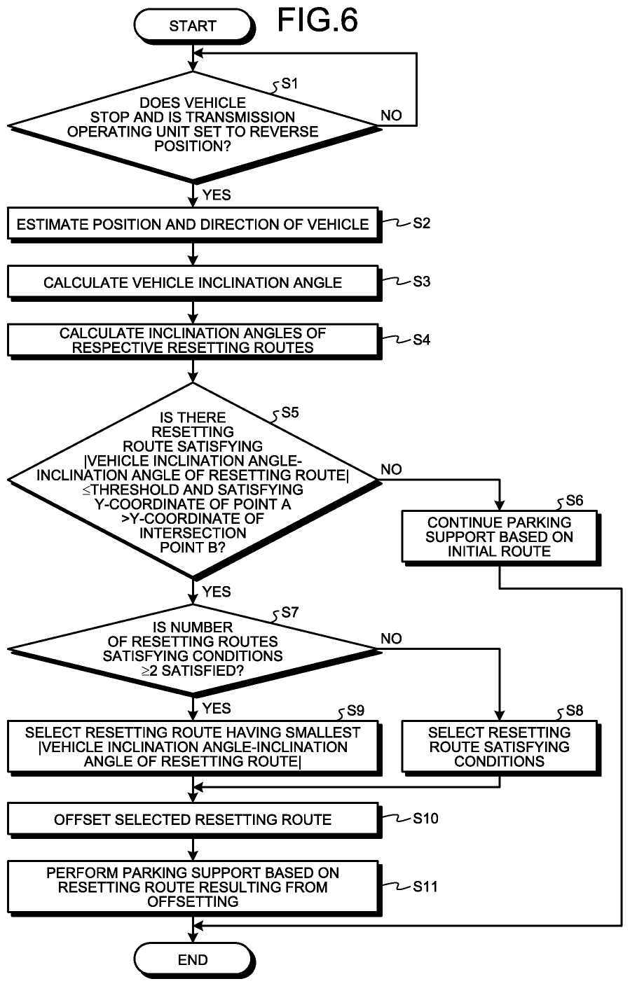

The following describes selection of the resetting route R according to the present embodiment explained above. FIG. 6 is a flowchart of an example of a process of selecting the resetting route R according to the present embodiment. The processing of the flowchart is started when the parking support is being performed by the ECU 14. It is assumed that the processing of the flowchart is started when, for example, the movement control unit 144 starts to move the vehicle 1 along the initial route calculated by the route calculating unit 143.

The own vehicle position estimating unit 145 determines whether the vehicle 1 stops and whether the movable part of the transmission operating unit 7 is set to the reverse position during the parking support (S1). When the vehicle 1 does not stop or when the vehicle 1 stops but the movable part of the transmission operating unit 7 is not set to the reverse position (No at S1), the own vehicle position estimating unit 145 performs the processing at S1 again.

When the own vehicle position estimating unit 145 detects that the vehicle 1 stops and that the movable part of the transmission operating unit 7 is set to the reverse position during parking support (Yes at S1), the own vehicle position estimating unit 145 estimates the position and the direction of the vehicle 1 (S2). The position of the vehicle 1 at this timing corresponds to the turning-back position A of the vehicle 1.

The inclination calculating unit 146 calculates the vehicle inclination angle θA (S3). Specifically, the inclination calculating unit 146 estimates the line 900 indicating the longitudinal direction of the vehicle 1 at the turning-back position A based on the turning-back position A estimated by the own vehicle position estimating unit 145 and the position of the target parking area F specified by the target position determining unit 142. The inclination calculating unit 146 then calculates the vehicle inclination angle θA that is the intersection angle between the line 900 and the X-direction extending along the entrance of the target parking area F.

The inclination calculating unit 146 calculates the inclination angles θB of the respective resetting routes R (S4). Specifically, the inclination calculating unit 146 calculates the position of the intersection point B from the turning-back position A estimated by the own vehicle position estimating unit 145 and the track of the resetting route R2 stored in the storage unit 150. The inclination calculating unit 146 estimates the line 800 indicating the longitudinal direction of the vehicle 1 when the vehicle 1 is positioned at the intersection point B on the resetting route R2, based on the position of the intersection point B and the position of the target parking area F. The inclination calculating unit 146 calculates the inclination angles θB of the respective resetting routes R, which is the intersection angle between the line 800 and the X-direction extending along the entrance of the target parking area F.

The inclination calculating unit 146 calculates the difference between the vehicle inclination angle θA and the inclination angles θB of the respective resetting routes R.

The selecting unit 147 determines whether there is a resetting route R that satisfies both the first condition and the second condition. Specifically, the selecting unit 147 determines whether there is a resetting route R having an absolute value of the difference between the vehicle inclination angle θA and the inclination angle θB of the resetting route R equal to or smaller than the predetermined threshold and having the Y-coordinate of the intersection point B smaller than that of the turning-back position A (point A) (S5).

When there is no resetting route R that satisfies both the first condition and the second condition (No at S5), the selecting unit 147 selects none of the resetting routes R. In this case, the movement control unit 144 continues parking support for the vehicle 1 based on the initial route (S6). When it is difficult to continue parking support based on the initial route, the movement control unit 144 may display guidance on the monitor device 11, for example, thereby notifying the driver of termination of parking support or instructing the driver to start manual operations.

When there is a resetting route R that satisfies both the first condition and the second condition (Yes at S5), the selecting unit 147 determines whether the number of resetting routes R satisfying the both conditions is two or more (S7).

When the number of resetting routes R satisfying the both conditions is not two or more (No at S7), that is, when the number of resetting routes R satisfying the conditions is one, the selecting unit 147 selects the resetting route R satisfying the conditions as an object to be reset (S8).

When the number of resetting routes R satisfying the both conditions is two or more (Yes at S7), that is, when there two or more resetting routes R that satisfy the both conditions, the selecting unit 147 selects the resetting route R having a smaller absolute value of the difference between the vehicle inclination angle θA and the inclination angle θB as an object to be reset (S9).

The route correcting unit 148 offsets the resetting route R selected by the processing at S8 or S9 to the turning-back position A in the Y-direction (S10). The offsetting performed by the route correcting unit 148 causes the intersection point B on the resetting route R to shift to the turning-back position A.

The movement control unit 144 resumes parking support for the vehicle 1 based on the resetting route R resulting from the offsetting (S11).

At this point, processing of the flowchart is terminated. When parking support is resumed by the processing at S6 or S11, the processing of the flowchart is performed again.

In some conventional parking support apparatuses, when the position of the vehicle deviates from the initial route set at the start of parking support, it may be difficult to guide the vehicle to the target parking area, or parking accuracy may be deteriorated, or turning-back operations for correcting the parking position may increase.

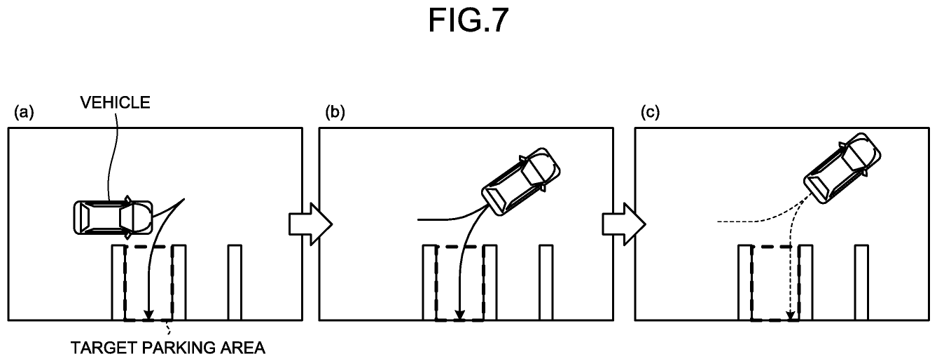

FIG. 7 is a diagram for explaining an example of conventional techniques. it is assumed that the initial route is set such that the vehicle moves forward, turns back, and then moves backward to park in the parking area, as illustrated in FIG. 7(a). When the vehicle moves along the initial route, the driver stops the vehicle at the position illustrated in FIG. 7(b) and sets the movable part of the transmission operating unit 7 to the reverse position.

It is assumed, however, that the driver causes the vehicle to go beyond the turning-back position (position of the vehicle illustrated in FIG. 7(b)) set in the initial route, stops the vehicle at the position illustrated in FIG. 7(c), and then sets the movable part of the transmission operating unit 7 to the reverse position. Some conventional techniques have difficulty in correcting the initial route when the vehicle turns back at a position different from the turning-back position set in the initial route. In this case, the vehicle moves to a position different from the original target position because the vehicle follows a route having the same turning radius as that of the initial route but moves from a turning-back position different from that of the initial route. As a result, the vehicle is parked at a position deviating from the center of the target parking area, as illustrated in FIG. 7(c). In other words, in the example illustrated in FIG. 7(c), a difference arises between the actual parking position and the target parking position, thereby resulting in lower parking accuracy. When the parking support apparatus or the driver in the above state performs alignment operation for parking the vehicle at the center of the target parking area, the number of turning-back operations may increase.

Some conventional parking support apparatuses have lower parking accuracy and other disadvantages not only when the driver causes the vehicle to go beyond the turning-back position set in the initial route and then stops the vehicle but also when the driver stops the vehicle before the turning-back position. Furthermore, some conventional parking support apparatuses have lower parking accuracy and other disadvantages when the vehicle does not follow the initial route due to various factors, such as parking environment and difference in operations between vehicles, other than the operations performed by the driver. With the vehicle deviating from the initial route, some conventional parking support apparatuses have difficulty in continuing parking support and switch to manual driving.

By contrast, in the ECU 14 according to the present embodiment, the selecting unit 147 selects the resetting route R at the turning-back position A. Thus, even when the vehicle 1 does not follow the initial route, the ECU 14 according to the present embodiment can park the vehicle 1 at the target position P with higher accuracy and suppress the increase in the number of turning-back operations.

As described above, in the ECU 14 according to the present embodiment, the storage unit 150 stores in advance a plurality of resetting routes R having different turning radii of the vehicle 1. The selecting unit 147 selects, at the turning-back position A, one of the resetting routes R. At that time, the selecting unit 147 selects one resetting route R based on the magnitude of difference between the direction of the vehicle 1 at the turning-back position A to the target position P and the direction of the vehicle 1 to the target position P when the vehicle 1 is positioned on the movement route. Consequently, even when the vehicle 1 turns back at the turning-back position A different from the position set on the initial route, the ECU 14 according to the present embodiment can shift the vehicle 1 to the resetting route R for moving the vehicle 1 to the target position P. Therefore, the ECU 14 according to the present embodiment can guide the vehicle to the target position P with higher accuracy. Since the ECU 14 according to the present embodiment can guide the vehicle to the target position P along the resetting route R, it is possible to suppress the increase in the number of alignment and turning-back operations. As described above, in the ECU 14 according to the present embodiment, the storage unit 150 stores in advance a plurality of resetting routes R. Thus, it is possible to lower the processing load in comparison with a case where another movement route is newly calculated.

The inclination calculating unit 146 of the ECU 14 according to the present embodiment calculates the vehicle inclination angle θA and the inclination angles θB of the respective resetting routes R. The selecting unit 147 selects the movement route having an absolute value of the difference between the vehicle inclination angle θA and the inclination angle θB of the resetting route R equal to or smaller than the threshold. Consequently, the ECU 14 according to the present embodiment can reduce the number of resetting routes R stored in the storage unit 150 while securing parking accuracy of a predetermined level or higher.

Among the resetting routes R stored in the storage unit 150 of the ECU 14 according to the present embodiment, a resetting route R turning at a position closer to the target parking area F has a smaller turning radius. The selecting unit 147 selects the movement route closer to the target parking area F than the turning-back position A is. Consequently, the ECU 14 according to the present embodiment can prevent the vehicle 1 from passing over the frame lines and the like surrounding the target parking area F, thereby guiding the vehicle 1 to the target parking area F with higher accuracy.

When there are two or more resetting routes R that are selectable, the selecting unit 147 of the ECU 14 according to the present embodiment selects the resetting route R having a smaller absolute value of the difference between the vehicle inclination angle θA and the inclination angle θB of the resetting route R. As a result, the ECU 14 according to the present embodiment can select the resetting route R closer to the present position and direction of the vehicle 1. Consequently, the ECU 14 can shift the vehicle 1 to the selected resetting route R more smoothly.

The route correcting unit 148 of the ECU 14 according to the present embodiment translates the resetting route R selected by the selecting unit 147 to the turning-back position A in the Y-direction. Consequently, the ECU 14 according to the present embodiment can perform parking support from the present position of the vehicle 1 without moving the vehicle 1 to shift it to the selected resetting route R.

Modifications

While the vehicle 1 according to the foregoing embodiment moves backward to enter into the target parking area F, it may move forward to enter into the target parking area F.

While the parking support performed by the ECU 14 according to the foregoing embodiment supports the vehicle 1 in entry to the parking area, the parking support is not limited thereto. The parking support performed by the ECU 14 may include supporting exit of the vehicle 1 from the parking area, for example. In this case, the target position P may be set on a road outside the parking area, for example. When the vehicle 1 turns back under the support of exit, the ECU 14 may carry out selection of the resetting route R.

While exemplary embodiments according to the present invention have been described, the embodiments and the modifications thereof are given by way of example only and are not intended to limit the scope of the invention. The embodiments and the modifications may be implemented in a variety of other forms. Various omissions, substitutions, combinations, and changes may be made without departing from the spirit of the invention. The configuration and the shape of the embodiments and the modifications may be implemented by being partially replaced.

What is claimed is:

1. A parking support apparatus comprising:
a memory configured to store in advance a plurality of movement routes having different turning radii of a vehicle; and
a hardware processor coupled to the memory, the hardware processor being configured to:
select one movement route from the plurality of movement routes based on magnitude of difference between a direction of the vehicle to a target position at a turning-back position where the vehicle turns back and a direction of the vehicle to the target position when the vehicle is positioned on the movement route; and
move the vehicle based on the selected movement route.

2. The parking support apparatus according to claim 1, wherein the hardware processor
calculates
a vehicle inclination angle that is an intersection angle between a longitudinal direction of the vehicle at the turning-back position and a first direction extending along an entrance of a target parking area, the target parking area including the target position, and
a movement route inclination angle that is an intersection angle between the first direction and the longitudinal direction of the vehicle at an intersection of the movement route and a reverse start reference line being parallel to a second direction perpendicular to the first direction and passing through the turning-back position, and
selects the movement route having an absolute value of difference between the vehicle inclination angle and the movement route inclination angle equal to or smaller than a threshold.

3. The parking support apparatus according to claim 2, wherein
the movement route that turns at a position closer to the target parking area out of the plurality of movement routes has a smaller turning radius, and
the hardware processor selects the movement route closer to the target parking area than the turning-back position is.

4. The parking support apparatus according to claim 2, wherein, when there are movement routes being selectable, the hardware processor selects the movement route having a smaller absolute value of difference between the vehicle inclination angle and the movement route inclination angle.

5. The parking support apparatus according to claim 2, wherein the hardware processor translates the selected movement route to the turning-back position in the second direction.
